(19) United States
(12) Patent Application Publication
(10) Pub. No.: US 2013/0171609 A1
(43) Pub. Date: Jul. 4, 2013

(54) Connecting Users in an Education Platform

(71) Applicants: Vincent Le Chevalier, San Jose, CA (US); Brent S. Tworetzky, Palo Alto, CA (US); Ashit Joshi, San Jose, CA (US); Dax Eckenberg, Los Gatos, CA (US); Rahul Ravindra Mutalik Desai, San Jose, CA (US); Charles F. Geiger, San Jose, CA (US)

(72) Inventors: Vincent Le Chevalier, San Jose, CA (US); Brent S. Tworetzky, Palo Alto, CA (US); Ashit Joshi, San Jose, CA (US); Dax Eckenberg, Los Gatos, CA (US); Rahul Ravindra Mutalik Desai, San Jose, CA (US); Charles F. Geiger, San Jose, CA (US)

(21) Appl. No.: 13/715,992

(22) Filed: Dec. 14, 2012

Related U.S. Application Data
(60) Provisional application No. 61/741,773, filed on Dec. 29, 2011.

(51) Int. Cl. G09B 19/00

(52) U.S. Cl. CPC G09B 19/00
USPC 434/365

(57) ABSTRACT

An education digital reading platform suggests connections between users, wherein the users are represented as nodes in a social graph. The nodes may be identified from education materials and course registrations associated with a course and a user. The education digital reading platform also determines suggested connections between the nodes based on the education materials and the course registrations, wherein the suggested connections are based on a commonality between the nodes, such as being registered to a similar course, having the same major, etc. The determined suggested connections are provided to the users. If the users accept the suggested connections, communication and other services are enabled between the users. Such a method of connecting users may iterate when new users or information is added to the platform, such as when a student registers for a new course or a new syllabus is received.

### CROSS REFERENCE TO RELATED APPLICATIONS

This application claims the benefit of U.S. Provisional Application No. 61/741,773, filed Dec. 29, 2011, which is incorporated by reference in its entirety.

This application is related to U.S. Provisional Application No. 61/741,771, filed Oct. 4, 2011, which is incorporated by reference in its entirety.

### BACKGROUND

1. Field of the Invention

This invention relates to connecting users using an educational platform to enable communication and services between the connected users.

2. Description of the Related Art

The education publishing industry faces a number of significant challenges to effectively delivering media and services through an on-line delivery network. These challenges center around five discrete phases:

1. Ingestion: A lack of digital textbook standardization, a plethora of incompatible formats, and a lack of integration and interoperability between publishers makes it difficult to ingest and aggregate a large volume of educational content efficiently and reliably.
2. Publishing: Significant transformation of education content needs to be undertaken to ensure that the content is suited to publish across a variety of client devices that users may use to access the content.
3. Distribution: In an electronic distribution environment, particular attention needs to be given to issues of content protection and rights management, as well as service policies and quality of service, so that content providers are fairly compensated and users of the content perceive the value and reliability of the service.
4. Connected Services: In an educational platform, there exists the potential to deliver a rich user experience that extends beyond electronic access to textbooks. To implement such connected services would require complex business rules and content models that are unavailable in existing education digital publishing services.
5. Connecting Users: In an educational platform, there exists the potential to connect users to enhance users' experience by enabling users to share educational materials with each other and learn from each other. To implement such connections between users would require detailed information about users that is unavailable in existing education digital publishing services.

Effectively enabling and managing each of the above four phases has not yet been accomplished by the education publishing industry. Accordingly, this has inhibited the growth of delivering media and services through an on-line delivery network.

### SUMMARY

Embodiments of the invention provide an education digital reading platform that provides aggregation, management, and distribution of digital education content and services. An education digital publishing platform ingests content from a variety of content sources, transforms the content for web-based publication, distributes the content to connected end-user devices, and displays content to a user to deliver a rich user experience wherein the user can interact with the distributed content in ways that are unavailable in a traditional educational platform.

In one embodiment, the education digital reading platform leverages information about a user by connecting the user with others who may be interested in communicating with the user. The education digital reading platform identifies such information about students based on ingested materials associated with the student, including for example, course registrations, syllabi, etc. In one embodiment, the education digital reading platform identifies information such as the student's teachers for classes, classmates, etc., to find other users of the education digital reading platform who are also classmates of the students, the student's teachers, authors of textbooks assigned to the students, etc. The connections are presented to the users of the education digital reading platform wherein the users may authorize the connections to enable communications between each other. Such a method of recommending connections may iterate when new users or information is added to the platform, such as when a student registers for a new course or a new syllabus is received.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates a block diagram of a system environment of an education digital reading platform in accordance with an embodiment of the invention.

FIG. 2 illustrates a block diagram for a system for identifying and recommending connections for a user within an education digital reading platform in accordance with an embodiment of the invention.

FIG. 3 illustrates a course registration in accordance with an embodiment of the invention.

FIG. 4A illustrates a student's social graph within an education digital reading platform, in accordance with an embodiment of the invention.

FIG. 4B illustrates a teacher's social graph within an education digital reading platform, in accordance with an embodiment of the invention.

FIG. 4C illustrates an author's social graph within an education digital reading platform, in accordance with an embodiment of the invention.

FIG. 5 illustrates a process for providing connections to users of an education digital reading platform, in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

The successful and rapid growing adoption of electronic books and web based publishing services is sometimes limited by the available digital content to offer. Publishers have to separately create digital versions of their content besides printed copies to support the new digital offerings. This separate process may introduce increased costs, digital format issues, and production delays that negatively affect the availability of the digital books at content and service providers. Given the average number of pages contained in a book or document, the large and increasing volume of books and documents to process, and the ever evolving and expanding list of consumer devices and software platforms capable of receiving digital content, manual conversion and visual testing in the traditional publishing solutions becomes more and more impractical. Therefore it is highly desirable to have an automated system for converting and testing extremely large volume of contents across permutations of multiple target devices and platforms.

In addition, despite the advance in digital conversion technologies and on-going standardization efforts in the creation and deployment of the electronic books, such as ePub standard and development toolkits, the converted digital content sometimes differs considerably from its original printed equivalent in at least one aspect: page fidelity. Page fidelity refers to the page structure of the original document, including the pagination of the original printed document, the number of columns and arrangement of paragraphs, the placement and appearance of graphics, titles and captions, and the fonts used. Page fidelity is usually not an issue for trade books given their relatively simple text structure and page layout. However, for some other categories of books (e.g., textbooks, education, travel, art, and cooking books), whose images, graphs, tables, maps, proprietary fonts, and multi-columns of text are assembled into complex sets of customized publications, maintaining page fidelity may be highly desired but quite challenging when converting into ePub format or modern markup language web pages.

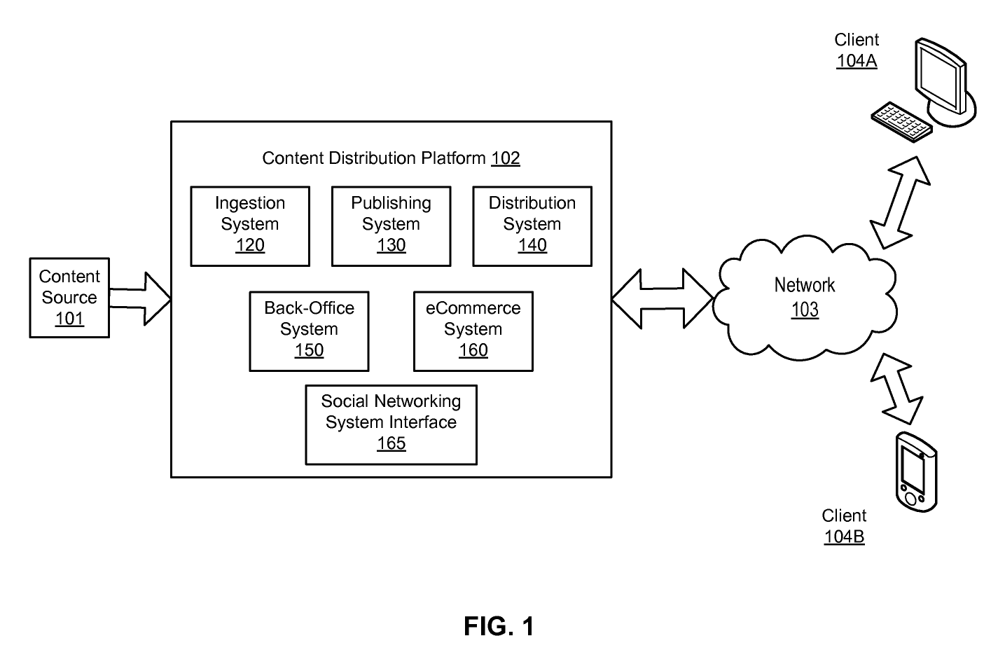

Embodiments of the invention provide a system referred to as a “document conversion testing system” or “publishing system.” The system transforms printed documents into, for example, markup language documents (e.g., in HTML5 web format) with enhanced metadata suited for distribution to a wide variety of computing devices. The system aims to preserve page fidelity, regardless of the original format of the source content provided by the content provider, and regardless of the complexity of the layout of the original document. To achieve the page fidelity perseverance, the system automatically analyzes and quantifies the differences in page fidelity between a printed document (e.g., a PDF file) and its markup language transformation (e.g., HTML5 web pages). Document pages that fail the page fidelity tests are flagged and examined. This publishing system is a part of an overall content distribution platform, an example of which is illustrated in FIG. 1. The content distribution platform not only facilitates aggregation, management, and distribution of digital education content, but also provides an integrated solution for digital publishing and online education services.

### Platform Overview

FIG. 1 illustrates a block diagram of a system environment for a digital content delivery and online education services in accordance with an embodiment of the invention. The system environment facilitates flexible distributions of digital books from publishers to end users. The content distribution platform 102 is described in more detail in patent application U.S. Ser. No. 13/253,011 titled “Electronic Content Management and Delivery Platform” filed on 4 Oct. 2011, the disclosure of which is incorporated herein by reference in its entirety.

As shown in FIG. 1, the digital reading environment comprises a content source 101, a content distribution platform 102, a network 103, and one or more clients 104. The content source 101 includes digital and printed content automatically gathered and aggregated from a large number of publishers, categories, and partners. Examples of content include textbooks, trade books, magazines, newspapers, user-generated content, web content, and advertising content.

The content distribution platform 102 aggregates, validates, transforms, packages, and monetizes the content collected by the content source 101 into a number of business services, prior to distribution to the clients 104 over the network 103. The platform comprises five systems: an ingestion system 120, a publishing system 130, a distribution system 140, a back-office system 150, and an eCommerce system 160.

The ingestion system 120 first gathers information on the type, file formats, and file manifest of the content. The ingestion system then checks files' integrity and conformity to standards, such as PDF, ePUB2, ePUB3, XML, HTML, and other formats. Content files that fail the integrity and conformity checks are flagged for further testing and repairing. Each content file that passes the checks is assigned a unique identifier and stored in a database for access by the publishing system 130.

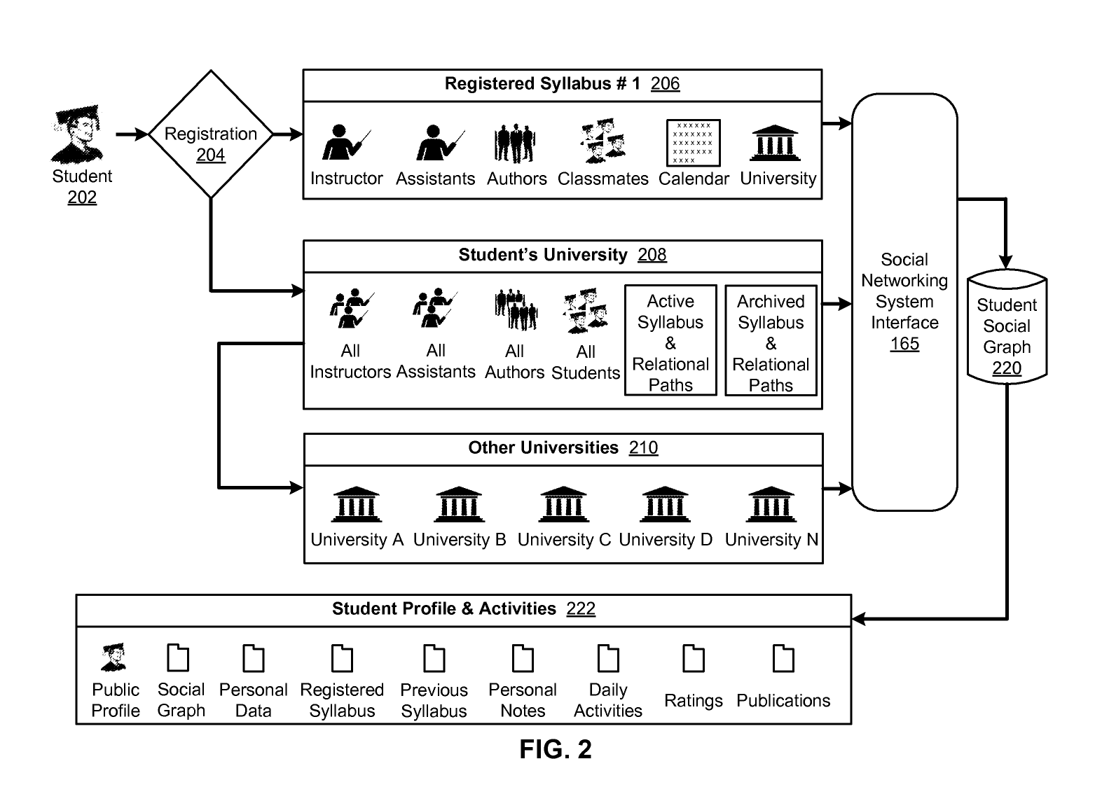

The publishing system 130 converts ingested documents into markup language documents, for example, an HTML5 web page with enhanced metadata, which is well-suited to distribution across a wide variety of computing devices connected to the content distribution platform 102 via the network 103. Due to the original format of the source content and the complexity of the layout of the original document, the converted markup language documents are tested by the publishing system 130 to determine whether the conversion preserves the page fidelity compared to the original printed document. The page fidelity includes the original page structure, such as the pagination of the original printed document, the number of columns and arrangement of paragraphs, the placement and appearance of graphics, titles and captions, and the fonts used. Only converted documents that meet a minimum requirement of page fidelity are approved for distribution. More details of the publishing system 120 are described with reference to FIG. 2 below.

The distribution system 140 packages the content for delivery and uploads the content to content distribution networks. Then, the distribution system 140 makes the content available to end-users based on the content's digital rights management policies.

The back-office system 150 handles tasks dedicated to running business within the content distribution platform, such as accounting, human resource, and project management. The back-office system 150 also manages the interactions with customers, clients, and sales.

The eCommerce system 160 manages the online processes of marketing, selling, servicing and receiving payments for digital products and services. Hence the eCommerce system 160 is closely interfaced to the publishing system 130, distribution system 140, as well as the back-office system 150.

The social networking system interface 165 identifies and suggests connections to users of the education digital reading platform based information about the student. The social networking system interface 165, for example, identifies other students, teachers, authors at the student's university or other universities who are registered for or teach classes similar to those of the student. The social networking system interface 165 suggests those other users to the student, wherein the student may accept the suggestion and communicate with them. The social networking system interface 165 is described in greater detail in reference to FIG. 2.

The network 103 facilitates content and service distribution and communications between various components of the system environment. Contents are packaged and distributed across the network 103 for client consumption. The overall quality of service received by the clients is also monitored and reported back to the content distribution platform 102 over the network 103. The network 103 is typically a content delivery network (CDN) built on the Internet, but may include any network, including but not limited to a LAN, a MAN, a WAN, a mobile wired or wireless network, a private network, or a virtual private network.

The clients 104 access the content from web browsers on computing devices connected to the network 103. The computing devices include a personal computer, such as a desktop, laptop, or tablet computer, a personal digital assistant, a mobile or smart phone, or a television “set-top box” using a client web application. The educational content are transformed by the content distribution platform 102 and delivered to the clients 104 across the network 103. As the clients enjoy the consistent reading experiences and high-quality services, the web browsers on the clients' devices regularly communicate with the content distribution platform 102 for updating reading content and connected services. In addition, user data on the clients' experience with the service and quality of the network connections are also collected and uploaded to the content distribution platform 102 through network 103.

In contrast to existing digital publishing services, such as AMAZON KINDLE®, the disclosed content distribution platform does not require users to purchase a specific client device or download a specific application from the service provider to access the content. Rather, any HTML5 compatible browser on a user's computing device may receive, from the content distribution platform 102, structureless HTML5 page elements to construct pages of a document on the browser, along with a host of document specific metadata to enhance the user's reading experience with the document, such as thumbnail navigation and an interactive table of contents. The HTML5 pages of the document also supports a number of reading activities, such as creating highlights, taking notes, and accessing a dictionary Annotations, such as highlights, drawings, notes, comments, and other personalized data created by the user can be displayed as an overlay on the original content, stored and archived in the user account, synchronized across all registered devices of the user, and optionally shared among the user's friends, classmates, campus, or other groups, as part of an education social platform. It is noted that although embodiments of the invention are described herein with reference to HTML5, other markup languages with suitable characteristics may also be used in place of HTML5.

### Suggesting Connections

FIG. 2 illustrates a block diagram for a system for identifying and recommending connections for a user within an education digital reading platform in accordance with an embodiment of the invention. In one embodiment, when a student 202 registers 204 for a course, the social networking system interface 165 identifies other users of the education digital reading platform who may be interested in communicating with each other based on the student's course registration 204. Such users are suggested to the student and added as connections on the student's profile 222 if the student and the users accept the suggestion. In one embodiment, connected students and users are enabled to communicate with each other in a variety of ways within the education digital reading platform, which enables various services to be provided to them.

In one embodiment, a student 202 registers 204 for a course. The course registration may occur anytime, but generally occurs before the beginning of an education period, such as a semester, a quarter, etc. An education period may be defined as a period between a first class of a course and a final exam of the course. In one embodiment, the education digital reading platform receives a student's course registration from the student 202, from an educational institution offering the course or from a third party service or an application. In one embodiment, the student's course registration identifies users (hereinafter also referred to as “nodes”) of the education digital reading platform, such as teachers, teaching assistants, etc. In addition the course registration may provide a user identifier (ID) based on which, the education digital reading platform may identify a user's major, grade level, classes taken, associations, interests, etc. In one embodiment, the users or nodes are connected to each other based on information in the course registration and other education materials.

In one embodiment, the education digital reading platform identifies a course material, such as, for example, a syllabus 206 associated with a course. The syllabus 206 may include information associated with the course. For example, the syllabus 206 may include but is not limited to information identifying the course's instructor, the instructor's teaching assistants, author of books assigned for reading, other students also registered for the class, a calendar of activities including deadlines for readings assignments, homework, in-class assignments, exams, projects and an educational institution such as a university wherein the course is administered. It is noted that some of the information found in a syllabus, such as students registered for a course, the university administering the course, may also be identified from the course registrations. In one embodiment, the information provided in the syllabus is ingested by the education digital reading platform to identify dates and materials that may be of interest to the user. In one embodiment, the education digital reading platform identifies other users via the course syllabus, wherein the other users may be interested in communicating with the student 202 and vice-versa. Such users are suggested as connections to the student 202 by the social networking system interface 165 as described in greater detail below.

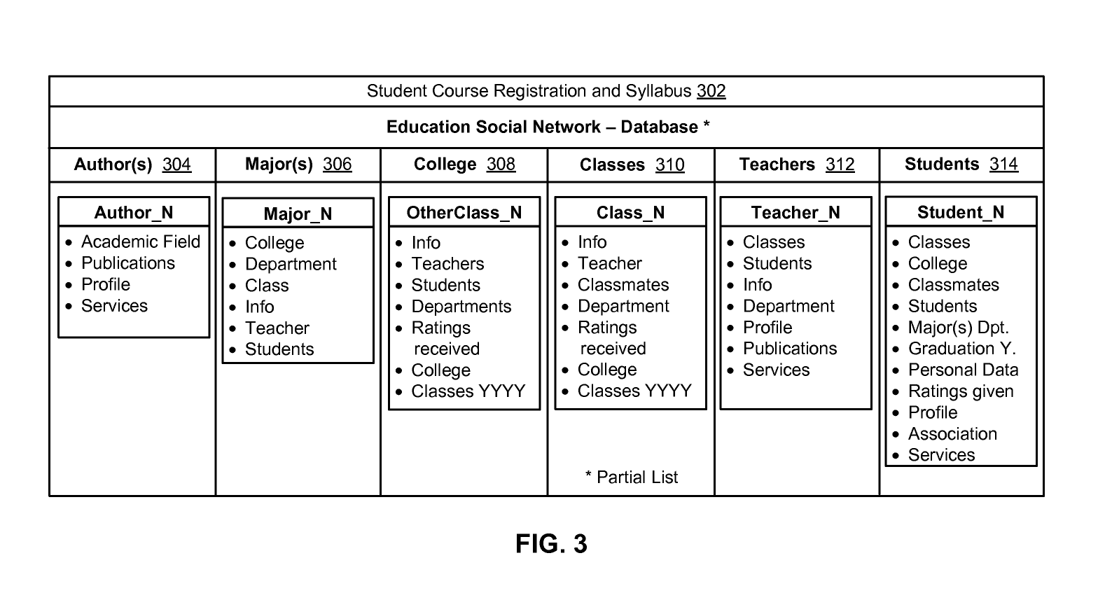

An example of the type of information identified from a student's course registration and a syllabus is provided in FIG. 3 in accordance with an embodiment of the invention. The course registration and syllabus may include information such as, but not limited to, authors 304 of books taught in a course, education majors 306 or focus areas associated with students taking the course or the course itself, college 308 or university offering the course, classes 310 offered by the university, teachers 312 teaching the courses offered by the university or college 308 and students 314 registered for courses offered by the university or college 310.

Information identifying authors 304 may include the author's name, academic field, publications, a profile of the author and services provided by the author such as tutoring, etc. Information identifying majors 306 include the majors offered by the university, a department overseeing or administering the major, classes or courses that are required, recommended or qualify for a major, information about the major, teachers associated with classes for the major, and student who have declared for each major. College 308 includes an educational institution wherein a student is registered to take a course. College information includes, information about the college, teachers providing services at the college, students registered at the college, departments within the college, ratings for teachers, courses, majors, departments, etc., and classes offered at the college 308. Information about the classes 310 include, information about the class, the class teacher, classmates or students registered for the class, department overseeing or administering the class, rankings or ratings for the class or the teacher associated with the class, college administering or overseeing the class and related classes. Information about teachers 312 include, classes taught by the teacher, students who have taken classes with the teacher, information about the teacher, including credentials, experience, etc., department overseeing the teacher, the teachers profile, publications and services such as tutoring, office hours, etc. The student 314 information includes, classes taken by the student, colleges attended by the student, the student's classmates, majors declared by the student, actual and predicated graduation dates, personal data, ratings provided by the student, his or her profile, associations the student is a part of and services provided by the student, including tutoring, counseling, etc. The identified information described above are examples and others are possible. In one embodiment, the education digital reading platform permits users to opt-in to services wherein their information is shared with or received by the education digital reading platform. In another embodiment, the education digital reading platform observes privacy policies provided by education institutions as well as policies and rules enacted by any other governing entity. In one embodiment, the above information is used by the social networking system interface 165 to suggest connections between education digital reading platform users, as described below in the specification.

Referring again to FIG. 2, in one embodiment, the education digital reading platform identifies additional information about the student's educational institution 208. Education institutions may include, for example, schools, colleges, universities, etc. Education institutions are also referred to as universities and colleges in the specification and the figures herein. In one embodiment, the education digital reading platform identifies the additional information about the student's university in order to identify additional users to recommend for connection within the education digital reading platform. The additional students may be interested in communicating with the student 202 if for example, the other users are registered for a class that is similar to the student's class. In another instance, a university may offer several classes that teach one course, such as ‘Chemistry 101.’ In such an instance, other users who may be registered for the same course as the user, but are registered in a different class, may be interested in communicating with student 202 and vice versa. In one embodiment, the education digital reading platform identifies information associated with the student's university, including instructors and assistants teaching at the university, authors of books assigned for reading, students registered at the university, active syllabus for an upcoming educational period and archived syllabi for past educational periods. In one embodiment, the social networking system interface 165 identifies users that may be interested in communicating with a student from the student's university 208.

In one embodiment, the education digital reading platform identifies other universities 210 that may offer courses similar to the one provided in the student's course registration 204. For example, a course such as ‘Introduction to Organic Chemistry,’ may be offered by several universities. Similar courses may be identified based on a similarity in course titles, books taught, homework assigned, etc. In one embodiment, the education digital reading platform identifies such universities and students, instructors, authors, etc., associated with the course at each identified university. The social networking system interface 165 suggests the identified users at the other identified universities as connections to the student 202.

The social networking system interface 165 identifies users to suggest connections based on the information extracted by the education digital reading platform as described above in reference to FIGS. 2 and 3. In one embodiment, the social networking system interface 165 identifies other users of the education digital reading platform who may be interested in communicating with the student 202 and vice versa based on the student's course registration 204, registered syllabus 206, the student's university 208 and other universities 210. Users of the education digital reading platform may be interested in communicating with each other if they have a common teacher, research assignment, reading assignment, exam, etc. Additionally, users registered for the same course at a university or across several universities may be interested in interacting with each other to learn from and explain course materials to and from each other. In one embodiment, the users may share user generated content with each other, including, for example, notes, questions, highlights, etc. Similarly, teachers, teaching assistants and book authors may be interested in communicating with each other and students across various universities to receive feedback from students and to provide an enhanced educational experience.

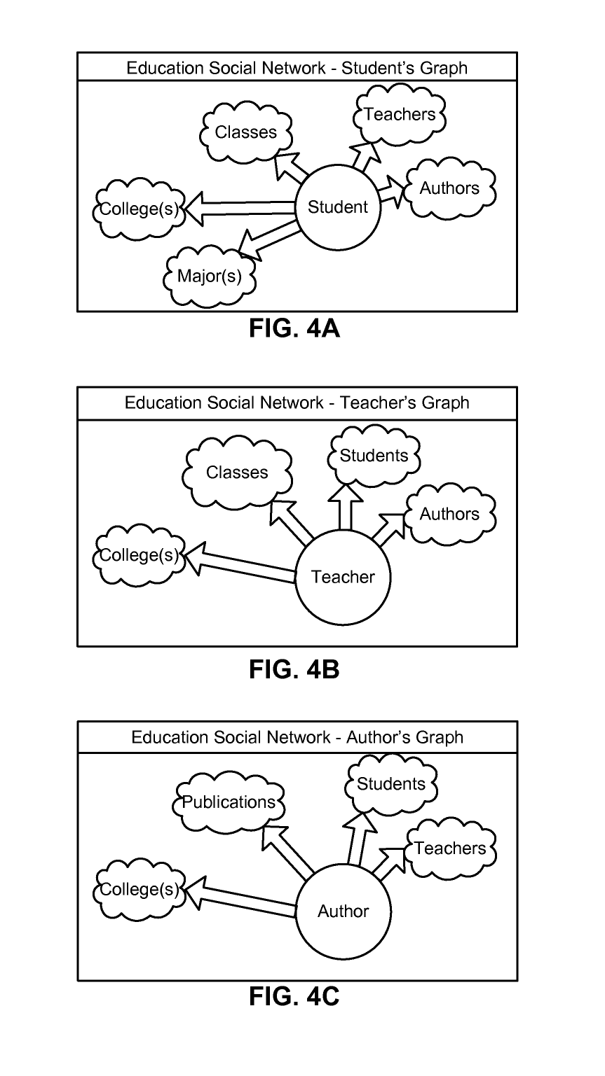

The social networking system interface 165 suggests such identified connections to the users of the education digital reading platform, wherein the users can either accept or reject the suggestions. If users accept the suggested connections, the social networking system interface 165 generates a social graph connecting the users with each other as described in reference to FIG. 4. The accepted connections between the users may be stored in a student social graph 220 database. In one embodiment, the student's 202 connections are provided on the student's profile and activities 222 interface, wherein the student 202 may view information ingested or created by the education digital reading platform. The information may include, for example, the student's public profile, social graph, personal data, registered syllabi, previous syllabi, personal notes, daily activities, ratings, publications, etc.

In one embodiment, the education digital reading platform is enabled to provide services to user based on their connections with other users within the education digital reading platform. Examples of services that may be provided, include but are not limited to access to supplemental academic material based, such as targeted quiz services and related course academic publications, notice of upcoming local events, such as an author's local speaking engagement and upcoming tests or exams, store merchandising or promotional content, such as tradebook publications related to course materials, local targeted advertising, such as coupon for local retail locations, and branded advertising such as national brands with their local representations.

FIG. 4 illustrates social graphs generated by the social networking system interface 165. FIG. 4A illustrates a social graph for a student. The student's social graph may include connections with teachers of courses that the student has registered for, authors of books that are assigned to the student as reading materials in one or more courses that the student has registered for and other students who share the same classes as the student, attend the same college as the student and have the same majors as the student. As described in reference to FIG. 2, the other students who share the same classes or courses and majors as the student may register for educational institutions other than the one wherein the student is registered. As such, the student's social graph within the education digital reading platform may be quite large and varied. In one embodiment, the social graph may be represented as nodes and edges connecting the nodes, wherein the nodes represent users of the education digital reading platform and edges represent the connections between the users. In one embodiment, students may communicate with their connections by sharing user generated content with each other, including notes, highlights, questions, etc.

FIG. 4B illustrates a teacher's social graph within the education digital reading platform. A teacher's social graph may include connections with students and authors of books assigned or taught by the teacher. In one embodiment, the other users connected to the teacher may be students who are registered for a course the teacher is teaching at one or more colleges wherein the teacher is teaching. As described in the specification, the social graph may be represented as nodes and edges connecting the nodes, wherein the nodes represent users of the education digital reading platform and edges represent the connections between the users. In one embodiment, teachers may communicate with their connections by allowing the connections to read their lecture notes, course outline materials, etc.

FIG. 4C illustrates an author's social graph within the education digital reading platform. The author may be connected to students who are registered for courses wherein the author's book is taught or assigned as reading material and teachers who are teaching or assigning the authors book in a course. Additionally, the author may be connected to students and teachers who have read or are reading a publication by the author and colleges wherein the author's book is assigned as reading. In one embodiment, the social graph may be represented as nodes and edges connecting the nodes, wherein the nodes represent users of the education digital reading platform and edges represent the connections between the users. In one embodiment, authors may communicate with their connections by allowing the connections to view an update or a revision to a text-book written by the author.

### Process for Suggesting Connections

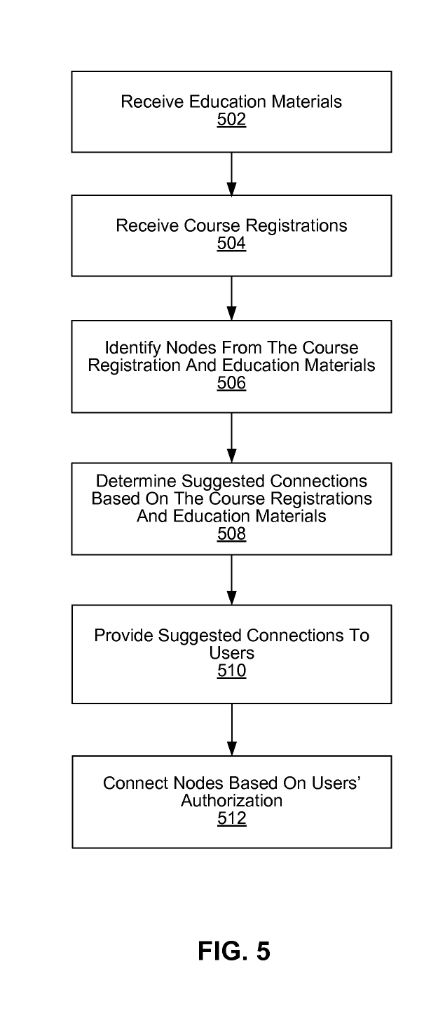

FIG. 5 illustrates a process for providing connections to users of an education digital reading platform, in accordance with an embodiment of the invention. In one embodiment, the process receives 502 education materials for students, including but not limited to syllabi for courses offered at one or more educational institutions. The education materials may include information such as teachers of the courses, authors of books taught in the course, etc. Additionally, the process receives 504 course registrations for one or more users of the education digital reading platform. The course registrations may include information such as an identifier of a student registering for a course, an identifier for the registered course, etc. The student's identifier may be used to identify additional information about the user, including, for example, the student's major, associations of the user, etc.

In one embodiment, the process identifies 506 nodes from the education materials and the course registrations to generate a social graph for a student. A node in a social graph represents a user of the education digital reading platform. In one embodiment, the process identifies 506 users such as other students, teachers and authors as nodes that may be connected to each other within a social graph.

In one embodiment, the process determines 508 suggested connections between the identified nodes based on the course registrations and the education materials. The suggested connections may be represented as edges that connect nodes within a social graph. In one embodiment, the process determines 508 the suggested connections between nodes if the nodes have certain common characteristics. For example, if two students have a same major or are registered for a same course, attend the same university, etc., the process determines 508 a suggested connection between the two students. Similarly, if any users of the education digital reading platform, including teachers, authors and students have certain commonalities, such as courses, majors, college, associations, a suggested connection is determined 508 between the users.

In one embodiment, the process provides 510 the suggested connections to the users. For example, if two students are determined to have a suggested connection via a course registration, the students are provided 510 the suggested connection, wherein the users may accept the suggested connection or reject it. Similarly, the suggested connections are provided 510 to all users of the education digital reading platform, including, students, teachers, authors, etc.

In one embodiment, if users accept the suggested connections, the process connects 512 the nodes representing the users within the education digital reading platform. In one embodiment, such a method of connecting users may iterate when new users or information is added to the platform, such as when a student registers for a new course or a new syllabus is received. The connection between the users enables the users to communicate with each other and learn from each other. For example, if a student has a question about a topic, the user may ask a question to a teacher connected to him or may seek to read notes written and shared by other users of a particular topic or page of a book to further enhance the educational experience. As such, the education digital reading platform is enabled to leverage connections between users to provide an enhanced learning experience to its users.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method of electronic content management and delivery, the method comprising:
identifying nodes based on education materials, the nodes including users associated with an education platform, the education materials providing information about at least one course;
suggesting connections between the nodes based on at least one course registration, the course registration associated with at least one education material; and
enabling the suggested connections based on an authorization, the connections enabling communication between the connected nodes.

2. The method of claim 1, further comprising identifying nodes based on the at least one course registration, the course registration including a student identifier and a course identifier.

3. The method of claim 1, wherein a node represents a student registered for a course at an educational institution.

4. The method of claim 1, wherein a node represents a teacher teaching a course at an education institution.

5. The method of claim 1, wherein a node represents an author of a book taught in a course at an education institution.

6. The method of claim 1, wherein the connections between nodes are suggested if the nodes share a commonality.

7. The method of claim 6, wherein the commonality between the nodes being identified is based on information provided in education materials and course registrations.

8. The method of claim 7, wherein the information provided in an education material includes an identifier for a textbook.

9. The method of claim 7, wherein the information provided in a course registration includes at least one of a student identifier, a course identifier and a teacher identifier associated with a registered course.

10. The method of claim 9, further comprising identifying information about a student based on the student identifier, including the student's major with an educational institution.

11. The method of claim 7, wherein the commonality between two nodes comprising a registration for a similar course, the similar course offered at different education institutions and offering similar education.

12. The method of claim 1, further comprising enabling various services between the connected nodes, the services including access to supplemental academic material based on connections between the user and other nodes.

13. A non-transitory computer-readable storage medium storing executable computer program instructions for electronic content management and delivery, the computer program instructions comprising instructions for:
identifying nodes based on education materials, the nodes including users associated with an education platform, the education materials providing information about at least one course;
suggesting connections between the nodes based on at least one course registration, the course registration associated with at least one education material; and
enabling the suggested connections based on an authorization, the connections enabling communication between the connected nodes.

14. The non-transitory computer-readable medium of claim 13, further comprising instructions for identifying nodes based on the at least one course registration, the course registration including a student identifier and a course identifier.

15. The non-transitory computer-readable medium of claim 13, wherein a node represents a student registered for a course at an educational institution.

16. The non-transitory computer-readable medium of claim 13, wherein a node represents a teacher teaching a course at an education institution.

17. The non-transitory computer-readable medium of claim 13, wherein a node represents an author of a book taught in a course at an education institution.

18. The non-transitory computer-readable medium of claim 13, wherein the connections between nodes are suggested if the nodes share a commonality.

19. The non-transitory computer-readable medium of claim 18, wherein the commonality between the nodes being identified is based on information provided in education materials and course registrations.

20. The non-transitory computer-readable medium of claim 19, wherein the information provided in an education material includes an identifier for a textbook.

21. The non-transitory computer-readable medium of claim 19, wherein the information provided in a course registration includes at least one of a student identifier, a course identifier and a teacher identifier associated with a registered course.

22. The non-transitory computer-readable medium of claim 21, further comprising instructions for identifying information about a student based on the student identifier, including the student's major with an educational institution.

23. The non-transitory computer-readable medium of claim 19, wherein the commonality between two nodes comprising a registration for a similar course, the similar course offered at different education institutions and offering similar education.

24. The non-transitory computer-readable medium of claim 13, further comprising instructions for enabling various services between the connected nodes, the services including access to supplemental academic material based on connections between the user and other nodes.
